(19) United States
(12) Patent Application Publication
(10) Pub. No.: US 2004/0091201 A1
(43) Pub. Date: May 13, 2004

(54) Optical micro-actuator, optical component using the same, and method for making an optical micro-actuator

(76) Inventors: Claire Divoux, Grenoble (FR); Claude Chabrol, Grenoble (FR)

Correspondence Address: Thelen Reid & Priest, PO Box 640640, San Jose, CA, 95164-0640, US

(21) Appl. No.: 10/433,752

(22) PCT Filed: Dec. 10, 2001
(86) PCT No.: PCT/FR01/03895

(30) Foreign Application Priority Data
Dec. 12, 2000 (FR) 00 16148

(51) Int. Cl. G02B 6/35

(52) U.S. Cl. 385/18

(57) ABSTRACT

The present invention relates to an optical micro-actuator comprising a cavity (30) formed between at least one optical input channel (12, 12a, 12b) and at least one optical output channel (14, 14a, 14b), the cavity being capable of containing at least one first optical fluid and one second optical fluid (32, 33, 34, 35), with different optical properties, and means of modifying the position of an interface between the first and second optical fluids with respect to the optical channels. According to the invention, the means of modifying the position of the interface comprise at least one chamber containing at least one fluid in fluid contact with the cavity, and means of modifying the volume of the chamber.

Application to making optical switches and mixers.

### CROSS-REFERENCE TO RELATED APPLICATION

This application claims priority based on International Patent Application No. PCT/FR01/03895, entitled “Optical Micro-Actuator, Optical Component Using The Micro-Actuator and Method for Making an Optical Micro-Actuator” by Claire Divoux and Claude Charbrol, which claims priority of French application no. 00/16148, filed on Dec. 12, 2000, and which was not published in English.

### TECHNICAL FIELD

This invention relates to an optical micro-actuator, an optical component using the micro-actuator and a method for making an optical micro-actuator.

An optical micro-actuator means a device capable of modifying at least one characteristic of a light beam in response to a control signal, and which may, for example, be integrated into an optical switching circuit.

This type of micro-actuator is used in applications for making optical components, for example such as relays, switches, attenuators, extinguishers or more complex devices such as optical switching circuits, optical mixers or optical multiplexers.

### STATE OF PRIOR ART

In order to modify a characteristic of a light beam, known micro-actuators comprise a particular optical medium that can be inserted in the light beam in response to a signal that is usually electrical. The medium inserted in the beam is capable of modifying the density of light flux, for example, to attenuate it or extinguish it, or to modify its direction. For example, this directs the beam towards an optical output channel selected among several possible output channels.

The medium inserted in the light beam may be a solid medium, a liquid medium or a gas medium.

The state of the art is mainly illustrated by documents (1) to (9), for which the complete references are specified at the end of the description.

More precisely, systems are known that use electro-optical or thermo-optical properties of some materials to modify the refraction index, the transparency or reflectivity on a medium through which the beam passes. For example, further information about this subject is given in document (4).

Other systems use a reflecting mirror, a more or less transparent blade, or a blade with a determined index that is placed in or removed from the optical path through which the beam passes.

Documents (1) and (2) indicate systems based on fluid ejection techniques or gas bubble production techniques.

Documents (3) and (8) indicate optical switches using the displacement of a liquid between two optical guides using a pump or a heating element.

All the devices mentioned above and illustrated in the documents mentioned have limitations related mainly to their operating frequency, or resonant frequency, and their life.

Devices equipped with mechanical moving parts are adversely affected by the inertia of these parts. Their response times to control signals are relatively long and they require a high control energy.

Devices that use a liquid or gas medium are highly sensitive to the environment and are affected by vibrations, shocks or repeated temperature variations. Furthermore, the liquid medium may also have a non-negligible inertia and limit the operating frequency.

### PRESENTATION OF THE INVENTION

The purpose of the invention is to propose an optical micro-actuator that does not have the limitations of the devices mentioned above, or for which these limitations are less restrictive.

One particular purpose is to propose an optical micro-actuator with low mechanical inertia that can operate at high frequency.

Another purpose is to propose such an optical actuator that comprises a minimum number of moving parts and that has long life and/or good operating reliability.

Another purpose of the invention is to propose a simple and economic method for making the micro-actuator.

A final purpose of the invention is to propose a number of particular applications of the micro-actuator.

To achieve these purposes, the objective of the invention is more precisely an optical micro-actuator comprising a cavity formed between at least one optical input channel and at least one optical output channel, the cavity being capable of containing at least one first optical fluid and one second optical fluid, with at least one different optical property, and means of modifying the position of an interface between the first and second optical fluids with respect to the optical channels. In this device, the means of modifying the position of the interface comprise at least one chamber containing at least one fluid in fluid contact with the cavity, and electrostatic control means to modify the volume of the chamber.

Thus, depending on operation of the micro-actuator, at any given instant the cavity may contain one of the fluids only or both fluids. Obviously, each fluid can overflow from the cavity as a function of the structure of the micro-actuator.

Furthermore, interface means an intermediate zone located between the two fluids that may have an almost zero thickness if the two fluids are immiscible, or a thickness adapted as a function of the required application (for example, the thickness of a beam) if the two fluids are partially miscible. The interface is not necessarily plane.

The micro-actuator may comprise at least N optical input channels and M optical output channels, in which each optical input channel may be selectively connected to at least one of the optical output channels through the cavity. N and M denote integers that are not necessarily equal.

For example, the optical input and output channels may be materialized by optical light beam transmission guides, or more simply by optical connection terminals in which such guides can be fitted. The “cavity” is usually no more than a simple space separating the input and output channels.

The first and second fluids, and more generally all optical fluids used, are preferably chosen with different optical properties. In particular, these properties may be reflection, transmission or refraction properties.

Thus, a light beam will be influenced differently by the different optical fluids that the beam encounters or passes through.

Depending firstly on the position of the interface between the two fluids and the angles between the optical center lines of the input and output channels, and secondly the walls of the cavity interrupting the optical channels, a light beam passing through the cavity between the input channel and the output channel can pass through one or the other of these fluids, or a variable proportion of each of the fluids. In particular, this takes place when the optical channels are not in the same plane as the interface. Depending on the choice of optical fluids and the angles defined above, an incident beam may also be refracted, diffracted or reflected without passing through the fluid present in the cavity.

Finally, it is considered that the chamber is in fluid relation with the cavity when a fluid displacement in the chamber causes a fluid displacement in the cavity. This does not necessarily mean that a fluid is actually circulating freely from the chamber towards the cavity. For example, the chamber may open up directly into the cavity, be connected to it through a variable length channel or possibly even isolated by a transmission element such as a deformable closer. This type of element also avoids contact between fluids.

According to a particular embodiment of the micro-actuator, means of modifying the volume of the chamber may comprise a deformable membrane forming a wall of the chamber.

The use of a membrane minimizes the number of moving parts and enables high operating frequencies.

According to one advantageous characteristic of the invention, the area of the free surface of the membrane may be chosen to be greater than and even very much greater than the area of the section of the cavity. Thus, a very small deformation of the membrane results in a large displacement amplitude of the fluids in the cavity. The small displacements of the membrane then enable even higher operating frequencies.

Several solutions may be envisaged to provoke a movement of the membrane in response to a control signal. For example, the membrane may be equipped with electrostatic control means. For example, these include a first electrode fixed to the deformable membrane and a second electrode fixed to a rigid support placed facing the first electrode. Contact points are also provided on the said electrodes to enable electrostatic control. These contact points are preferably made by a metallic deposition in the plane of the electrodes, possibly after etching to enable opening in the layers covering the electrodes. Starting from these contact points, the control is conventionally made by wire techniques and/or by transferring an interconnection substrate.

Note that the electrode fixed to the membrane may itself form the membrane.

Other control means, for example piezoelectric, magnetic, thermal, pneumatic means, etc., may be used, or a combination of these means may also be used.

According to another possibility, the chamber may comprise a bladder containing at least one driving fluid or optical fluid, and the means of modifying the volume of the chamber can be provided with means of compressing the bladder. Since the bladder is leaktight, the means of compressing the bladder do not have to be leaktight, and for example can consist of an actuatable flexible beam.

In one embodiment of the micro-actuator forming a variant of the embodiment described above, the micro-actuator may comprise at least one first chamber in fluid relation with the cavity and at least one second chamber in fluid relation with the cavity. In this case, the means of modifying the volume of the chamber may comprise at least one deformable chamber forming a wall of at least one chamber. Preferably, each chamber is connected to a distinct end of the cavity. Obviously, it would also be possible to envisage the case in which each chamber is connected to the same end. If two or more chambers are used, a combination of these two cases may be envisaged.

As mentioned above, a micro-actuator conform with the invention may be used in a component chosen from among optical relays, optical extinguishers, optical switches and optical attenuators. Similarly, an optical mixer may comprise several optical micro-actuators according to the invention.

The invention also relates to a method for making a micro-actuator in a structure consisting of a stack of layers comprising the following steps:

formation of at least one fluid chamber in the structure, with a rear part of the chamber containing a first electrode,

release of the part of the rear part of the chamber thus formed to make a membrane and to expose the first electrode,

formation of at least one optical channel in the structure, making a cavity separating at least two parts of the optical channel, the cavity being coincident with the chamber,

formation of a second electrode facing the first electrode, this second electrode enabling movement of the membrane.

The steps in the method may be done in this order or in a different order.

According to a first embodiment of the method of making an optical micro-actuator, the method includes:

formation of a fluid chamber in or on a first substrate comprising the first electrode,

formation of at least one optical channel in or on a second substrate and etching a cavity separating the optical channel into at least two parts,

assembly of the first substrate and the second substrate, making the cavity coincide with the chamber,

release of part of the first substrate through the rear face, to form the membrane and to expose the first electrode,

transfer a third substrate comprising a second electrode onto the first substrate, the third substrate being transferred onto the first substrate through shims enabling movement of the membrane.

According to a second embodiment of the method for making the optical micro-actuator, the method comprises the following steps:

formation of at least one fluid chamber in a first substrate with a first layer comprising the first electrode and a second layer comprising the second electrode, these two electrodes being separated by an isolating layer,

formation of the said optical channel in or on a second substrate and etching a cavity separating at least two parts of the optical channel,

assembly of the first substrate and the second substrate, making the cavity coincide with the chamber,

release of part of the first layer comprising the first electrode to form a membrane, by etching part of the isolating layer from the rear face of the first substrate.

In accordance with a preferred embodiment of the method, a first substrate comprising a solid silicon part can be used, and a stack can be formed on this solid part comprising an electrical isolating layer and a non-isolating layer in which:

the fluid chamber is formed in a layer of material covering the said stack, and

when the membrane is released, the solid part of the first substrate is eliminated and at least one layer of the stack of layers is kept as a membrane, the non-isolating layer of the stack forming an electrode fixed to the membrane.

“Non-insulating” means materials that conduct electricity in the normal sense of the term, for example such as metals, and also semiconducting materials, for example such as polycrystalline silicon, and monocrytalline and amorphous silicon.

The micro-actuator chamber may be defined mainly in a layer of material covering the substrate. For example, it may be an open chamber that will only be closed, at least partially, when the first and second substrates are assembled. Layers forming optical guides can then also form the walls of the chamber.

Other characteristics and advantages of the invention will become clear after reading the following description with reference to the figures in the attached drawings. This description is given purely for illustrative and non-limitative purposes.

### BRIEF DESCRIPTION OF THE FIGURES

FIG. 1 is a diagrammatic section through an optical actuator according to the invention;

FIGS. 2A and 2B are simplified diagrammatic views of an optical switch using an optical actuator according to the invention;

FIGS. 3 to 8 are diagrammatic sections through an optical actuator of the type shown in FIG. 1, and illustrate the successive steps in the method for manufacturing such an actuator;

FIGS. 9, 10 and 11 are diagrammatic sections illustrating the possibilities of making other optical actuators according to the invention, forming variants of the device in FIG. 1;

FIG. 12 is a diagrammatic section through an actuator conform with the invention and forming a variant of the actuator in FIG. 1;

FIG. 13 is a simplified diagrammatic cross sectional view of a micro-actuator with two chambers according to the invention;

FIG. 14 is an enlarged section XIV-XIV through the micro-actuator in FIG. 13;

FIG. 15 is a simplified diagrammatic cross sectional view through a double micro-actuator according to the invention;

FIG. 16 is a simplified diagrammatic cross sectional view of a micro-actuator according to the invention and corresponding to an improvement.

### DETAILED PRESENTATION OF EMBODIMENTS OF THE INVENTION

In the following figures referred to in the description, identical, similar or equivalent parts are marked with the same numeric references. Furthermore, for reasons of clarity in the figures, different parts are not shown at the same scale.

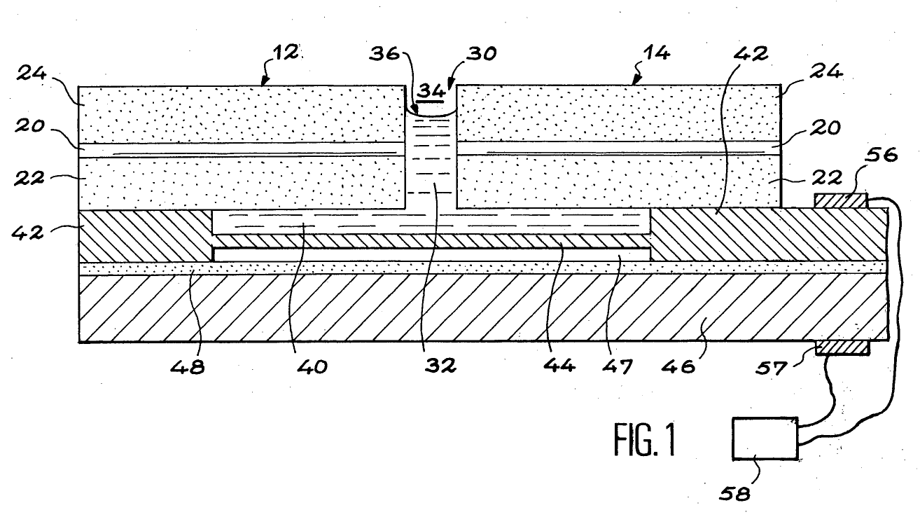

FIG. 1 shows an optical actuator conform with the invention. It comprises an optical input channel 12 and an optical output channel 14. In the example in the figure, the optical channels are optical input and output guides. The optical guides are formed by stacks of layers; they form a core 20 placed between two confinement layers 22 and 24 respectively. The guides may be connected to optical fibers, not shown.

According to another possibility, the guides may also be composed directly of optical fibers used for transferring or transmission of a light beam or signal.

The optical input and output channels have ends separated by cavity 30. The figures show a single optical input channel and a single optical output channel. However, several other optical channels may open up into the same cavity 30.

The cavity 30, which in the case in FIG. 1 is delimited mainly by layers 20, 22 and 24 forming optical guides, contains two fluids with different optical properties. In the example shown, the first fluid is a liquid 32 with a first refraction index and the second fluid is a gas 34, for example air, which has a second different refraction index, for example less than the first refraction index. The first and second fluids are separated by an interface marked as reference 36. Preferably, the index of the first fluid is similar to the index of the core 20 of optical guides.

The cavity 30 is in a fluid contact with a chamber 40 that contains a large proportion of the first fluid 32. Although not essential for smooth operation of the actuator, it is preferable if the variable volume of fluid contained in the chamber 40 is almost incompressible. The chamber 40 is delimited by the confinement layers 22 of the optical guides, by rigid sidewalls 42 and by a flexible membrane 44. All these wall elements are assembled to each other in a fixed and rigid manner such that none of the elements slide like a piston with respect to the other elements.

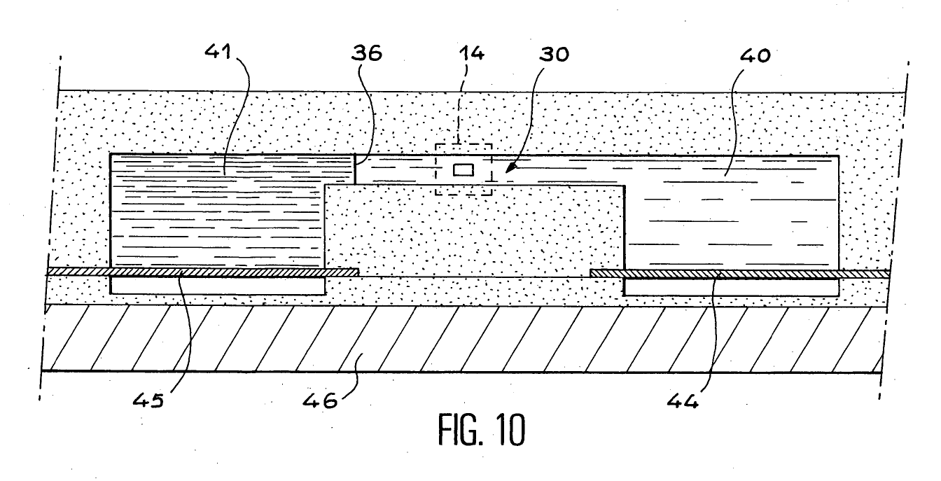

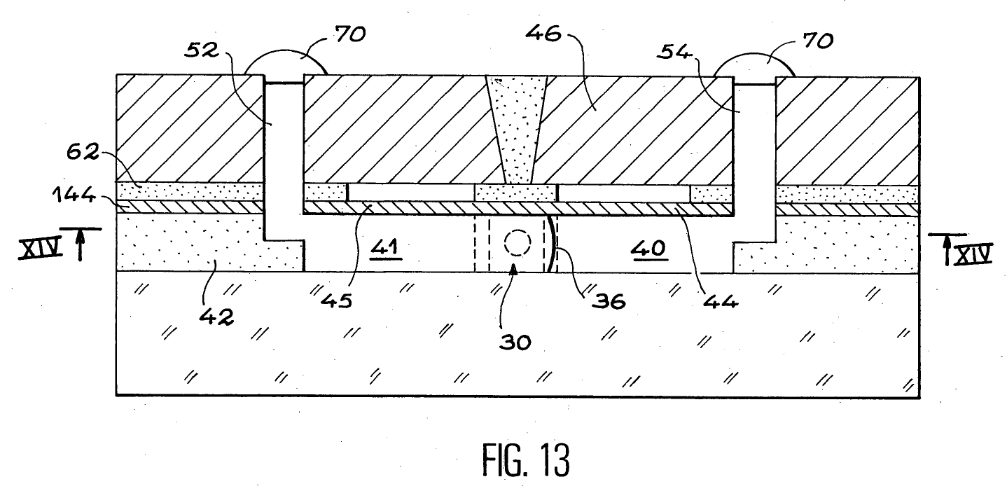

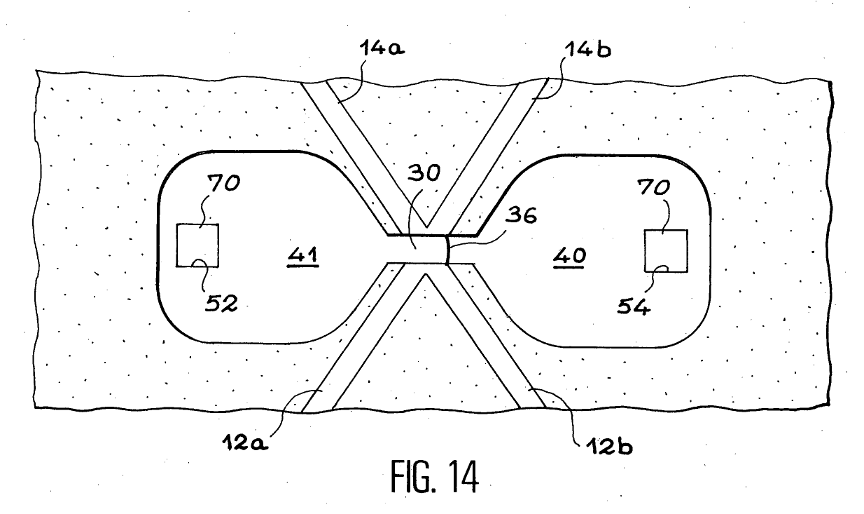

The flexible nature of the membrane 44 is used to modify the volume of the chamber 40. A modification to the volume of the chamber causes a modification to the height of the first fluid 32 in the cavity 30, in other words a displacement of the interface 36 between the first and second fluids. The relative quantity of the first fluid and the second fluid may be adjusted such that the interface 34 moves approximately to the height of the cores 20 of the optical guides of the input and output channels 12, 14. In this case, bending of the membrane modifies the medium present in the cavity through which a light beam originating from the optical input channel passes. More precisely, in the example in the figure, the interface between the first and second fluids is a surface approximately parallel to the orientation of the cores of the optical guides 12, 14 that form input and output channels. The effect of moving the interface above or below the propagation plane of the light beam originating from the input guide 12, is that the beam passes through the first fluid 32, or the second fluid 34. The transition between these two states may be clean-cut or it may be more progressive depending on the position of the interface and its thickness. In other examples (for example such as FIGS. 10 and 13 described later) in which the interface is not approximately parallel to the plane defined by the cores of the optical guides, a more progressive transition will also be possible with a beam passing through a variable proportion of the first and second fluids.

In using a transparent fluid and a more or less opaque fluid for the light beam, it is possible to form a switch or an optical attenuator, for example.

Bending of the membrane 44 may be caused for example by electrostatic control means. These comprise a first electrode fixed to the membrane and a second electrode facing the membrane and fixed to a rigid support.

A very low chamber 47 is provided between the electrodes to enable actuation of the membrane at low voltage.

It is considered that the first and second electrodes are fixed to the membrane and the fixed support either when they are placed on these parts, or when they are composed of these parts. In the case illustrated in FIG. 1, the membrane 44 and the rigid support 46 form the first and second electrodes respectively, and consequently are made of a non-insulating material. Contact areas 56, 57, for example metallic contact areas, each placed on one of the two electrodes, connect the electrodes to a voltage generator 58 capable of applying a potential difference ΔV between the electrodes. The connection between the contact areas and the generator is made either using wire techniques or using an interconnection substrate.

The distance between the electrodes is adjusted as a function of the surface area of the electrodes, the value of the potential differences that can be output by the generator, and as a function of the stiffness of the membrane such that the electrostatic forces applied between the fixed support and the membrane are sufficient to cause a deflection that can create a variation of the volume in the chamber. The distance between the electrodes also fixes the maximum deflection amplitude of the membrane. In this respect, note that a layer 48 of electrical insulating material covers the rigid support 46 to prevent a short circuit between the electrodes by contact or by flash over.

A cap may also enclose the structure. This cap may comprise a recessed substrate facing the cavity and deposited onto the optical guides. In particular, this cap limits evaporation of the fluids and may contain another fluid.

As an illustration, a 1 μm thick 200 μm diameter silicon membrane with a resonant frequency of 100 kHz, and capable of deflecting by 0.27 μm at its center, will require a distributed pressure of approximately 2700 Pa. This corresponds to an electrostatic force applied between the two electrodes separated by 1 μm, and subjected to a potential difference of less than 50 V.

In the example given above, it is considered that the variation of the volume of the chamber must correspond to a variation of the volume in the cavity in order to displace the interface 36 of the optical fluids on each side of a region in which the optical guides open up. The variation of the volume in the example considered is 2800 μm³. This corresponds to a capillary cavity 30 with a cross section of 20×7 μm², and to a displacement of the interface of 20 μm. In special cases, the displacement amplitude may be further reduced to the extent that the diameter of the beam output from an optical guide may be of the order of 9 μm. The displacement amplitude or the displaced volume may be larger for operating reliability reasons, for example during expansion of the fluids present due to temperature.

According to one advantageous aspect of the actuator construction, the membrane 44 of the chamber 40 may have a very much larger area than the cross section of the cavity 30 that separates the ends of the optical guides. Thus, a small membrane deformation amplitude compatible with high operating frequencies is translated into a fast and higher amplitude modification of the position of the interface 36 of the fluids present in the cavity.

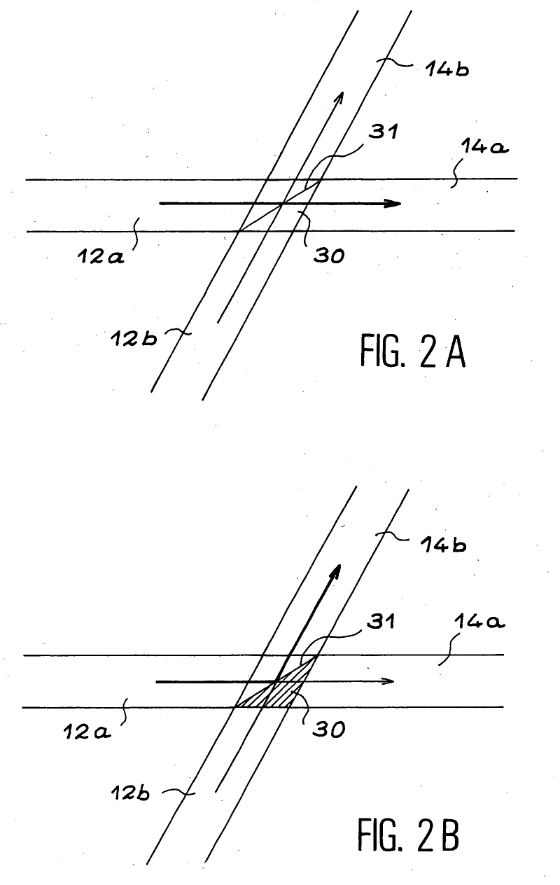

Use of an actuator conform with FIG. 1 as an optical switch is illustrated very diagrammatically by FIGS. 2A and 2B. References 12a and 12b indicate a first and second optical input channel that leads into a cavity 30 with a wall 31. The cavity 30 is a cavity of an actuator like that described below. The wall 31 corresponds to the intersection between the optical channel 12a and the cavity 30.

The references 14a and 14b relate to optical output channels coplanar with the optical input channels and also opening up into cavity 30.

The actuator may be in two switching states depending on whether the cavity 30 is occupied by a first or a second optical fluid. These two switching states are illustrated by FIGS. 2A and 2B respectively.

In the optical switching state corresponding to FIG. 2A, the cavity 30 is filled essentially with one of the optical fluids, for example water, such that the optical index of the medium on each side of the wall 31 is approximately the same. A beam from the first input channel 12a passes through the device and comes out of the device through an optical output channel 14a aligned with the first input channel.

Similarly, a beam from the second input channel 12b passes through the device and comes out of it through the optical output channel 14b aligned with the second input channel.

This switching state does not deviate the beam. The propagation of the beams is indicated by arrows.

In the switching state corresponding to FIG. 2B, the cavity 30 is filled essentially with an optical fluid for which the index is different from the index forming the optical guides, for example such that the optical index of the medium on each side of the. wall 31 is different and causes refraction. A beam from the first input channel 12a passes through the device and comes out of it through the optical output channel 14b aligned with the second input channel, rather than through the optical output channel 14a aligned with the first input channel.

Similarly, a beam from the second input channel 12b passes through the device and comes out of the device through the first optical output channel 14a aligned with the first input channel 12a.

This switching state deviates the beam.

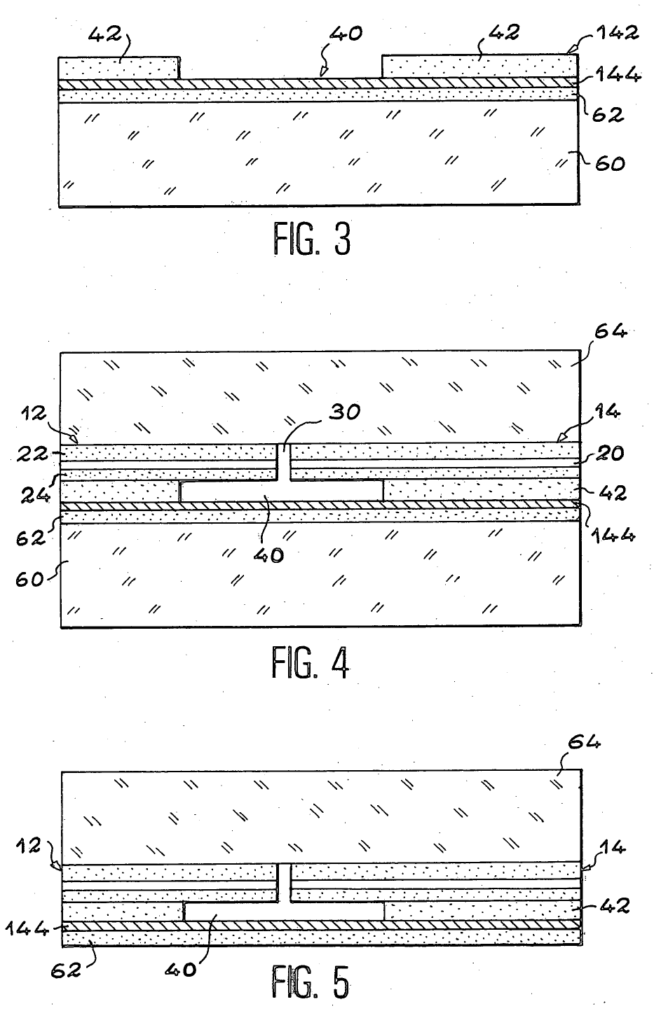

We will now describe a manufacturing method for an optical actuator of the type shown in FIG. 1, with reference to FIGS. 3 to 8.

A first step corresponding to FIG. 3 comprises formation of the chamber that will contain at least one of the optical fluids. For example, this chamber may be formed on an SOI (Silicon On Insulator) type substrate comprising a solid layer of silicon 60, a buried layer 62 of silicon oxide and a thin surface layer of silicon 144. The thin surface layer is of the order of 1 μm thick, for example. A thicker silicon oxide layer 142 is formed on the thin surface layer and is etched stopping on the thin silicon layer 144 to define the location and dimensions of the chamber 40. The sidewalls 42 of the chamber remain in place after etching of the silicon oxide layer 142.

A second sacrificial substrate 64 on which optical input and output guides 12, 14 are formed separated by cavity 30, is transferred and bonded onto the first substrate by bringing the optical guides 12 and 14 into contact with the sidewalls 42 of the chamber 40. Bonding may, for example, consist of direct molecular bonding or the use of a glue. This step is shown in FIG. 4.

The manufacture of optical guides is not described in detail here. It is. done using known optical confinement techniques consisting of surrounding an optical core 20 with confinement layers 22, 24. The refraction indexes of the materials from which the confinement layers are made are lower than the index of the core.

A subsequent step illustrated in FIG. 5 shows elimination of the solid part 60 of the first substrate. This operation takes place by etching, stopping on the buried silicon oxide layer 62.

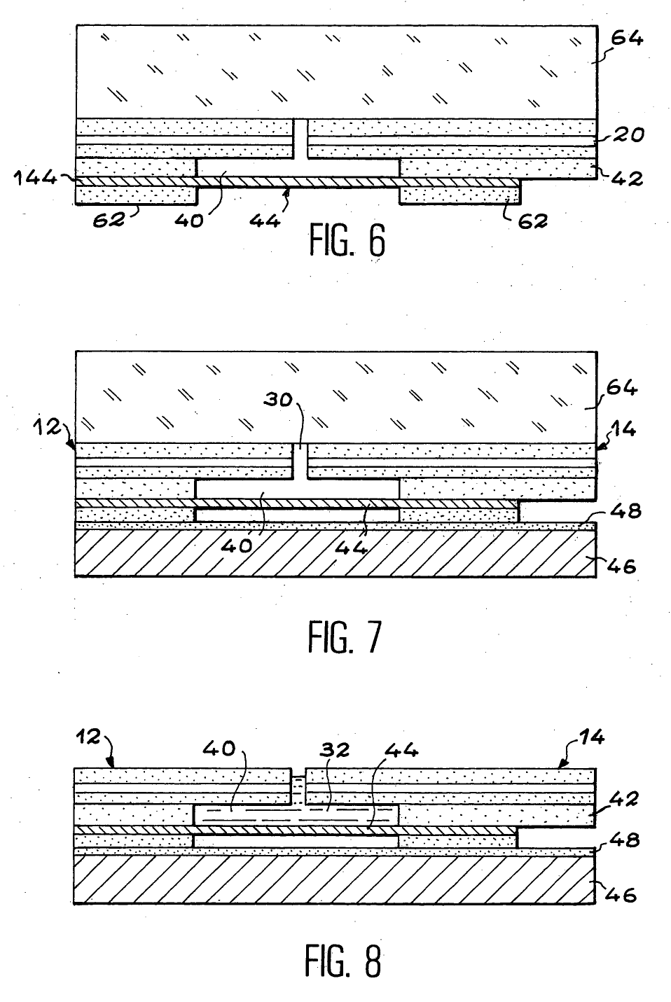

Part of the buried silicon oxide layer 62 is then also etched in a region coincident with the chamber 40. This etching defines the membrane 44 that corresponds to part of the thin silicon layer 144 exposed by etching. The membrane 44 can be seen in FIG. 6.

The device in FIG. 6 is then transferred onto a support substrate comprising a thick silicon layer 46 covered by a thin silicon oxide layer 48, as shown in FIG. 7. The transfer takes place by bringing the surface layer of silicon oxide 48 of the support substrate onto the part of the buried silicon layer 62 of the first substrate preserved during etching to expose the membrane. For example, bonding may take place by direct bonding or by using an intermediate glue layer.

FIG. 7 shows that the thickness of the buried oxide layer 62 of the first substrate partly determines the movement amplitude of the membrane. The oxide layer forms the sidewalls of an actuation cavity, in this case is full of air, which is a compressible gas, or a partial vacuum. The surface layer 48 of the support substrate forms electrical insulation between the electrodes, in other words between the membrane 44 and the thick silicon layer 46.

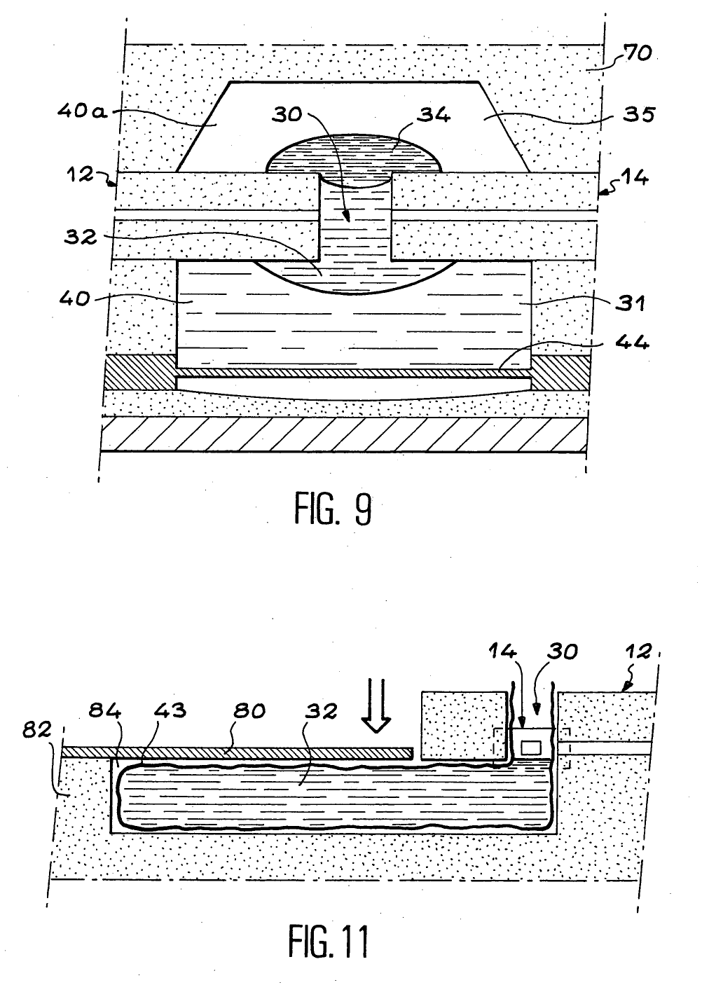

The next step shown in FIG. 8 includes elimination of all or part of the sacrificial substrate so as to open up the cavity 30. The device is completed by filling in the chamber 40 and part or all of the cavity 30 with a liquid or gel 32 forming the first optical fluid. Contacts may also be formed on the membrane and the support substrate 46 that form the electrodes of the electrostatic control means.

The final result is an actuator fairly similar to that shown in FIG. 1. The main differences are related to the choice of materials and the arrangement of the sidewalls 42 of the chamber 40.

We will now more briefly describe other embodiments of the invention.

FIG. 9 shows an optical actuator comprising a cavity 30 to which two distinct chambers 40 and 40a are connected. For example, the chamber 40a was formed by sealing a cap 70 after filling in the cavity. The chambers are connected to the cavity on each side of the optical guides 12, 14, forming the input and output channels.

The construction of the first chamber 40 is very similar to the chamber 40 in FIG. 1. It comprises a flexible membrane moved by electrostatic control means.

The chamber wall may be rigid or it may be fairly flexible to limit any attenuation of the movement of the interface 36. A compressible or incompressible ballast fluid 35 may be used if the wall of the chamber is flexible. The second chamber 40a does not have a membrane.

The first chamber contains a first fluid 31 called the driving fluid. For example, it may be an incompressible liquid that does not necessarily have any optical properties and for which the volume is not sufficient to reach the cavity. The driving fluid is only used to transmit movement of the membrane to the optical fluids. The optical fluids are marked with references 32 and 34.

The first optical fluid 32 extends from the cavity 30 in which it is in contact with the second optical fluid 34, as far as the first chamber 40. The second optical fluid 34 extends partly into the second chamber 40a. The chamber 40a is also filled with a ballast fluid, for example air or another compressible gas, to compensate for modifications to the volume of the first chamber 40. For example, the chosen driving fluid may be water, an oil, an alcohol, a dielectric liquid, a magnetic fluid, etc.

The optical fluid may be the same as the fluid used above, or atmospheric air or be in a partial vacuum.

Identical fluids may be chosen in some cases.

The optical actuator in FIG. 9 has the advantage that it is completely sealed from the external medium and therefore can only be slightly influenced.

FIG. 10 illustrates another example embodiment of an actuator according to the invention.

This actuator comprises two chambers 40 and 41 each comprising a flexible membrane 44, 45, moved by an electrostatic motor of the type already described. A conducting support layer 46 forms a fixed electrode, which in this example is common to the two motors. Each of the chambers contains an optical fluid, and they are connected to each other by a channel that forms a cavity 30 according to the meaning of the invention. One of the optical guides is shown in a simplified manner as reference 14. It opens up into the cavity in a zone in which the interface 36 between the optical fluids can move under the effect of deformation of the membranes. The displacement of the interface makes it possible to bring the end of the optical guide into contact sometimes with all or part of one of the optical fluids, and sometimes with all or part of the other optical fluids, and in this example the interface 36 is approximately perpendicular to the plane of the layers.

FIG. 11 shows yet another possible embodiment of the actuator. In the example in this figure, the variable volume chamber of the optical actuator contains a bladder 43 or is even formed by the bladder 43.

The bladder 43 is connected to the cavity 30 and essentially contains an optical fluid 32, the height of which in the cavity may be changed by modifying the volume of the bladder. The means of modifying the volume of the bladder comprise essentially a flexible beam 80, in which a first fixed end is fixed to a support 82 and a free end can more or less compress the bladder when the beam is bent towards the bladder. The beam is made to bend by any type of external actuation symbolized simply by an arrow. For example, actuation may be the result of a piston device, an electrostatic motor or an electromagnetic motor. Actuation may also take place directly on the bladder, and by means that would not be possible using microelectronics techniques (for example, electromagnet or piezoelectric actuator).

FIG. 11 shows the presence of two optical guides 12 and 14 that expand along directions approximately perpendicular to each other and opening up into the cavity 30.

One of the main advantages of the optical actuator in FIG. 11 consists of simplification of manufacturing of the chamber or more precisely, the receptacle 84 containing the optical fluid. Since the bladder acts as a chamber with variable volume and achieves the leak tightness necessary to keep the optical fluid, the receptacle 84 may be provided with openings, or at least its leak tightness does not have to be perfect.

The figures do not show any exhausts, to avoid making them too congested. However, the dimensions of exhausts may be such that they enable selective exhaust of the fluid to avoid damping of the interface movement.

Selectivity may be achieved particularly by varying the dimensions of the exhausts, surface treatments and/or the choice of materials to provide appropriate capillarity effects.

Similarly, the fluid filling holes and the plugs closing off these holes are not shown.

We will now describe variant embodiments of actuators according to the invention.

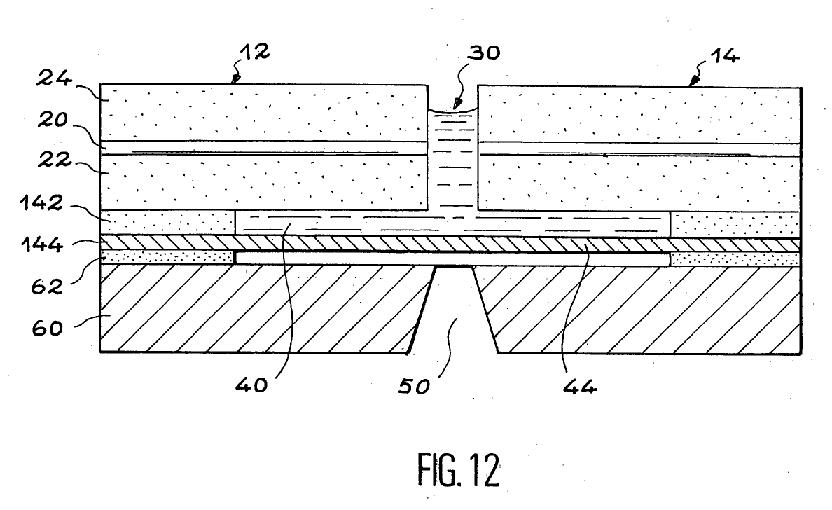

FIG. 12 shows an actuator with a structure similar to the structure of the actuator already described with reference to FIG. 1. The actuator is formed by assembly of a first substrate conform with the substrate described with reference to FIG. 3, and a second substrate on which optical guides 12, 14 are formed. After etching the chamber 40 in a silicon oxide layer 142, the first and second substrates are assembled by aligning the cavity 30 with the chamber 40.

An opening 50 is then formed in the solid part of the substrate comprising the thick layer 46 of silicon. The opening 50 passes through the layer 46 from one side to the other until it reaches the buried silicon oxide layer 62. Selective chemical attack formed through the opening 50 then partly etches the buried silicon oxide layer to release the thin layer 144 on its back face and thus form the membrane 44. The membrane 44 and the thick layer 46 of the silicon substrate form the electrodes of the corresponding electrostatic membrane actuation means.

The optical actuator in FIG. 13 is an actuator with two chambers 40 and 41 comparable to the actuator in FIG. 10. It also comprises an SOI type substrate with a “surface” layer 144 separated from a solid part by a buried isolating layer 162. The layer 144, which for example is a silicon layer, is used for forming the membranes 44 and 45. The chambers 40 and 41, and the channel 30, are formed in the same layer of material that is marked with reference 42 to correspond with the previous figures. The reference 36 denotes the interface between the optical fluids.

The references 52 and 54 indicate filling ducts of the chambers passing through a substrate 46. These ducts are used to fill the chambers with optical fluids after the substrates have been assembled. The ducts 52 and 54 are closed off by plugs 70. Finally, the optical guides are indicated very approximately as discontinuous lines.

FIG. 14 shows a section XIV-XIV located in FIG. 13, and gives a better view of the arrangement of the optical input and output guides. It can be observed that the device is provided with two optical input channels 12a and 12b and two optical output channels 14a and 14b.

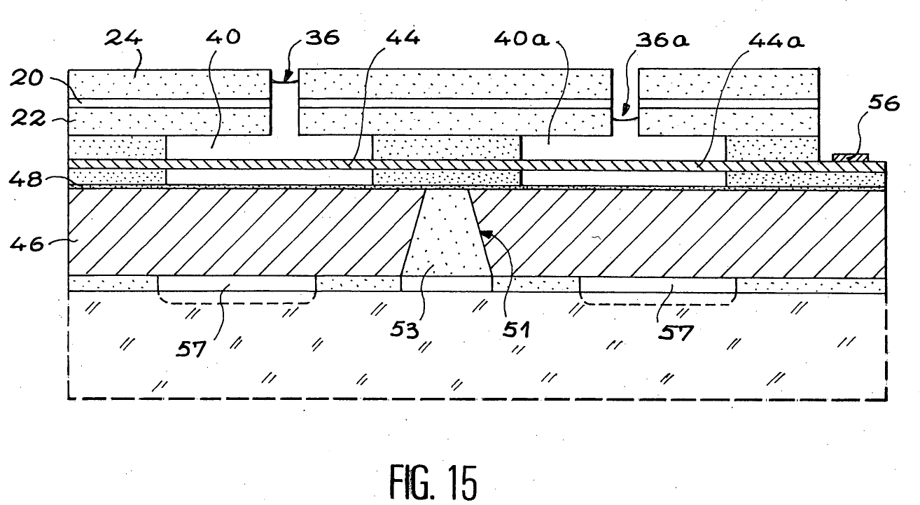

FIG. 15 shows a particular device including two optical actuators conform with the invention in the same substrate. The two actuators each have a chamber 40, 40a, each provided with a flexible membrane 44, 44a. In the same way as for the devices in the previous figures, the membranes also comprise electrodes cooperating with the thick layer 46 of the substrate that acts as counter-electrode. A trench 51 formed in the substrate extends from each side of the layer 46 and is filled with an electrical insulating material 53. The trench and the insulating material are designed to isolate two parts to the thick layer 46 that form counter-electrodes for the membranes of the two optical actuators. Contact areas 56a and 56b are formed on a rear face of the thick layer 46 and are separated by an electrical isolating layer. The rear face in this case is the face opposite the chambers 40 and 40a.

A control substrate indicated in discontinuous lines may be transferred on the face with contact areas 56a and 56b. For example, the control substrate has cornices coincident with the contact areas and may comprise a circuit for defining the matrix addressing and control of the contact areas. This circuit is not shown for reasons of clarity.

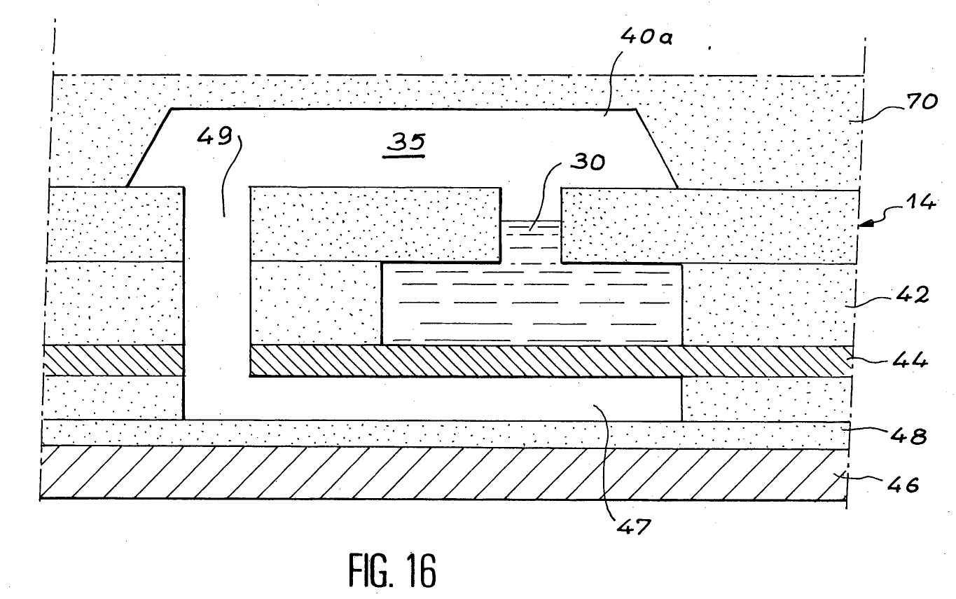

FIG. 16 shows a micro-actuator forming a variant of the micro-actuator described with reference to FIG. 9. It shows an improvement designed to compensate for the effects of a temperature fluctuation that could be applied to the device.

More precisely, the improvement is intended to compensate for the effects of expansion of a fluid and in particular the ballast fluid 35 contained in the second chamber 48. This fluid may be sensitive to temperature, particularly if it is a gas, and possibly cause unwanted switching when the switching threshold is low.

The micro-actuator in FIG. 16 comprises a vent duct 49 for this purpose that connects the second chamber 40a to the chamber 47 located on the other side of the membrane 44 opposite the cavity 30. The chamber 47 is partly delimited by the membrane 44, or possibly by the membrane actuation electrodes.

Thus, expansion of one of the fluids, or at least the ballast fluid, creates a pressure not only on a side of the fluid contained in the cavity 30, but also on the membrane.

The result is that the device is less sensitive to temperature.

The vent duct may be etched through the different layers of the stack.

Note that the section plane in FIG. 16 forms an angle with the section plane in FIG. 9, such that the optical channels cannot be seen in FIG. 16. The end of the optical channels open up into the cavity 30 but are not shown for reasons of clarity in the figure.

Another way of reducing sensitivity to temperature is to trap the same fluid at the same pressure in chambers 40a and 47 on each side of the cavity 30. In this case, the presence of a vent duct is superfluous. Finally, the entire device can be thermostat-controlled. However, these solutions are more difficult to apply.

Documents Mentioned

(1)

“Compact scalable Fiber Optic Cross-connect Switches” by J. E. Fouquets, S. Venkatesh, M. Troll, D. Chen; S. Schiaffino, P. W. Barth, Hewlett Packard laboratories, IEEE 1999

(2)

“Total internal reflection optical switches employing thermal activation”

U.S. Pat. No. 5,699,462 Hewlett Packard Company, 1997

(3)

“Optical Device or Switch for controlling radiation conducted in an optical waveguide” by Franz Auracher et al., U.S. Pat. No. 4,505,539 SIEMENS, 1985

(4)

“Optical Switch Array”

Segawa

U.S. Pat. No. 4,648,686 RICOH Ltd., 1997

(5)

“Fiber optic High speed pulse scanner” by Edward F. Mayer

U.S. Pat. No. 4,615,580 RICOH Ltd., 1986

(6)

“Optical switch using bubbles” by J. L. Jackel et al.

U.S. Pat. No. 4,988,157 Bell Communications Research, Inc., 1991

(7)

“Bistable optical switching using electrochemically generated bubbles”

by J. L. Jackel et al., Bell Communications Research, 1980, Optical society of America

(8)

“Automated Optical Main Distributed Frame System” by Kanai et al.

U.S. Pat. No. 5,204,921, NTT Corporation 1993 and

“Automated optical MDF System” by Kanai et al., EP 0 494 738 B1, NTT Corporation 1992

(9)

“Micromachined optical switch” by Aksyuk, Vladimir Anatolyevich et al.

EP 0 880 040 A2 Lucent Technologies Inc., 1998.

1. Optical micro-actuator comprising a cavity (30) formed between at least one optical input channel (12, 12a, 12b) and at least one optical output channel (14, 14a, 14b), the cavity being capable of containing at least one first optical fluid and one second optical fluid (32, 33, 34, 35), with at least one different optical property, and means of modifying the position of an interface between the first and second optical fluids with respect to the optical channels, in which the means of modifying the position of the interface comprise at least one chamber (40, 41, 43) containing at least one fluid in fluid contact with the cavity (30), and electrostatic control means (44, 46, 80) to modify the volume of the chamber.

2. Optical micro-actuator according to claim 1, in which the means of modifying the volume of the chamber comprise a deformable membrane (44, 45) forming a wall of the chamber.

3. Micro-actuator according to claim 2, comprising a first electrode fixed to the deformable membrane (44) and a second electrode fixed to a rigid support (46) placed facing the first electrode.

4. Micro-actuator according to claim 2, in which the membrane (44) has a free surface the area of which is greater than the area of one section of the cavity.

5. Micro-actuator according to claim 1, in which it the chamber comprises at least one flexible wall and contains at least one substantially incompressible fluid (31, 32).

6. Micro-actuator according to claim 1, in which the chamber has rigid walls, and contains at least one compressible fluid.

7. Micro-actuator according to claim 1, comprising a plurality N of optical input channels (12a, 12b) and a plurality M of optical output channels (14a, 14b), in which each optical input channel may be selectively connected to at least one of the optical output channels through the cavity.

8. Micro-actuator according to claim 1, comprising at least one first optical guide forming at least one input channel and at least one second optical guide forming at least one output channel.

9. Micro-actuator according to claim 1, in which the chamber contains at least one fluid chosen from among the first and second optical fluids (32, 34) and/or at least one driving fluid (31) with or without direct contact with at least one of the first and second optical fluids.

10. Micro-actuator according to claim 1, in which the chamber comprises a bladder (43) containing at least one of a driving fluid and an optical fluid, and the means of modifying the volume of the chamber comprise means (80) of compressing the bladder.

11. Micro-actuator according to claim 1, comprising at least one first chamber (40) in fluid relation with the cavity (30) and at least one second chamber (40a, 41) in fluid relation with the cavity and in which the means of modifying the volume of the chamber comprise at least one deformable membrane (44, 45) forming a wall of at least one chamber.

12. Micro-actuator according to claim 11, comprising a vent duct (49) connecting the second chamber (40a) in fluid relation with the cavity, to a chamber (47) located on one side of the membrane (44) opposite the cavity (30).

13. Micro-actuator according to claim 11, in which each chamber comprises a deformable membrane (44, 45) moved by an electrostatic motor.

14. Optical mixer comprising a plurality of optical micro-actuators conform with claim 1.

15. Use of a micro-actuator according to claim 1, in a component chosen from among optical relays, optical extinguishers, optical switches and optical attenuators.

16. Method for making an optical micro-actuator comprising the following steps:
formation of a fluid chamber (40) on a first substrate (60) comprising a first electrode (144),
formation of at least one optical channel (12, 14) on a second substrate (64) and etching a cavity (30) separating two parts of the optical channel,
assembly of the first substrate (60) and the second substrate, making the cavity coincide with the chamber,
release of part of the first substrate, through a back face, to form a membrane (44) and expose the first electrode
transfer of a third substrate (46, 48) comprising a second electrode (46) on to the first substrate, the third substrate being transferred onto the first substrate through shims (62) allowing movement of the membrane (44).

17. Method according to claim 16, in which use is made of a first substrate comprising a solid silicon part (60), and of a stack on this solid part, said stack comprising an electrical isolating layer (62) and a non-isolating layer (144) in which:
the fluid chamber is formed in a layer of material (42) covering the said stack, and
when the membrane is released, the solid part of the first substrate is eliminated and at least one layer of the stack of layers is kept as a membrane, the non-isolating layer of the stack forming an electrode fixed to the membrane.

18. Method according to claim 16, in which an open chamber (40) is formed in a layer of material (42) of the first substrate and the said chamber is closed when the first and second substrates are assembled.

19. Method for making a micro-actuator in a structure formed of a stack of layers, comprising the following steps:
formation of at least one fluid chamber in the structure, with a rear part of the chamber comprising a first electrode,
release of the part of the rear part of the chamber thus formed to make a membrane and to expose the first electrode,
formation of at least one optical channel in the structure and making a cavity separating at least two parts of the optical channel, the cavity being coincident with the chamber,
formation of a second electrode facing the first electrode, this second electrode enabling movement of the membrane.

20. Method for making the optical micro-actuator, the method comprising the following steps:
formation of at least one fluid chamber in a first substrate with a first layer comprising the first electrode and a second layer comprising the second electrode, these two electrodes being separated by an isolating layer,
formation of at least the said optical channel in or on a second substrate and etching a cavity separating at least two parts of the optical channel,
assembly of the first substrate and the second substrate, making the cavity coincide with the chamber,
release of part of the first layer comprising the first electrode to form a membrane, by etching part of the isolating layer from the rear face of the first substrate.
